(19) United States
(12) Patent Application Publication
(10) Pub. No.: US 2026/0261433 A1
(43) Pub. Date: Sep. 3, 2026

(54) AUTHENTICATION SYSTEM, TERMINAL, AND AUTHENTICATION METHOD

(71) Applicants: NEC Corporation, Tokyo (JP); Cyber Defense Institute, Inc., Tokyo (JP)

(72) Inventors: Atsushi NAGATA, Tokyo (JP); Toru TOMITA, Tokyo (JP)

(73) Assignees: NEC Corporation, Tokyo (JP); Cyber Defense Institute, Inc., Tokyo (JP)

(21) Appl. No.: 19/164,799

(22) PCT Filed: Mar. 28, 2023
(86) PCT No.: PCT/JP2023/012602

§ 371 Date: Sep. 12, 2025

(51) Int. Cl. H04L 9/32; G06Q 30/0645; H04L 9/08

(52) U.S. Cl. CPC H04L 9/3263; G06Q 30/0645; H04L 9/0861; H04L 9/3247

(57) ABSTRACT

An authentication system including a terminal and an authentication server, the authentication system including: the terminal including, memory storing instructions; and processor configured to execute the instructions to: generate a first private key relating to a user certificate that is linked to an endorsement key, and a second private key relating to a device certificate that is linked to the endorsement key; sign predetermined data using each of the private keys; and transmit, to the authentication server, signature data signed by each of the first private key and the second private key through encrypted communication; and the authentication server including, memory storing instructions; and processor configured to execute the instructions to: verify the signature data by using the user certificate and the device certificate held in advance; and enable when the user and the device are verified, connection of the terminal to the network system.

### TECHNICAL FIELD

The present disclosure relates to an authentication system, a terminal, an authentication server, an authentication method, and a recording medium.

### BACKGROUND ART

There is a technique of performing authentication using information of a user or a terminal when the user performs authentication to an authentication system via a network.

PTL 1 discloses a method of authenticating a user by verifying whether the user has signed a nonce transmitted from an authentication server with his/her private key.

### CITATION LIST

### Patent Literature

PTL 1: JP 2022-530136 A

### SUMMARY OF INVENTION

### Technical Problem

However, in the invention described in PTL 1, when performing authentication, a personal identification number (PIN) code input by a user is transmitted to an authentication server together with a nonce. For this reason, the secret of the authentication information used at the time of authentication is not secured. Therefore, when the authentication information is stolen on the network, it is difficult for the authentication server to detect impersonation of the user or the terminal.

An example of an object of the present disclosure is to provide an authentication system capable of verifying authenticity of a user and a terminal while protecting confidential information of the user and the terminal in authentication via a network.

### Solution to Problem

An authentication system according to one aspect of the present disclosure includes a terminal and an authentication server for using a network system from the terminal, in which the terminal includes,
a security function means for generating a first private key relating to a user certificate that is linked to an endorsement key, and a second private key relating to a device certificate that is linked to the endorsement key, and signing predetermined data using each of the private keys, and a transmission/reception means for transmitting, to the authentication server, signature data signed by each of the first private key and the second private key through encrypted communication, and the authentication server includes, a verification means for verifying the signature data by using the user certificate and the device certificate held in advance, and a connection means for enabling, when the user and the device are verified, connection of the terminal to the network system.

A terminal according to one aspect of the present disclosure includes: a security function means for generating a first private key relating to a user certificate that is linked to an endorsement key and a second private key relating to a device certificate that is linked to the endorsement key, and signing predetermined data using each of the private keys, and a transmission/reception means for transmitting signature data signed by each of the first private key and the second private key to an authentication server for authenticating a user and a device through encrypted communication.

An authentication server according to one aspect of the present disclosure includes a verification means for verifying a user and a device by using a user certificate and a device certificate held in advance for signature data signed by each of a first private key relating to the user certificate that is linked to an endorsement key and a second private key relating to a device certificate that is linked to the endorsement key received from a terminal to be authenticated, and a connection means for enabling, when the user and the device are verified, connection of the terminal to the network system.

An authentication method according to one aspect of the present disclosure is an authentication method for authenticating a terminal to use a network system by an authentication server, in which the terminal generates a first private key relating to a user certificate that is linked to an endorsement key, and a second private key relating to a device certificate that is linked to the endorsement key, and signs predetermined data using each of the private keys, and transmits, to the authentication server, signature data signed by each of the first private key and the second private key through encrypted communication, and the authentication server verifies the signature data by using the user certificate and the device certificate held in advance, and enables, when the verification is successful, connection of the terminal to the network system.

A recording medium according to one aspect of the present disclosure stores a program for causing a computer to generate a first private key relating to a user certificate that is linked to an endorsement key and a second private key relating to a device certificate that is linked to the endorsement key, and sign predetermined data using each of the private keys, and transmit signature data signed by each of the first private key and the second private key to an authentication server for authenticating a user and a device through encrypted communication.

A recording medium according to one aspect of the present disclosure stores a program for causing a computer to verify signature data signed by each of a first private key relating to a user certificate that is linked to an endorsement key and a second private key relating to a device certificate that is linked to the endorsement key received from a terminal to be authenticated using the user certificate and the device certificate held in advance, and
enable, when the verification is successful, connection of the terminal to the network system.

### Advantageous Effects of Invention

According to an example of the effect of the present disclosure, it is possible to verify the authenticity of the user and the terminal while protecting confidential information of the user and the confidential information of the user terminal.

### BRIEF DESCRIPTION OF DRAWINGS

FIG. 1 is a block diagram illustrating a configuration of an authentication system in the present disclosure.

FIG. 2 is a diagram illustrating a hardware configuration in which a terminal, a certification authority server, and an authentication server in the present disclosure are implemented by a computer device and its peripheral devices.

FIG. 3 is a flowchart illustrating an operation of the authentication system in the present disclosure.

FIG. 4 is a flowchart illustrating an operation of the authentication system in the present disclosure.

### EXAMPLE EMBODIMENT

Next, an example embodiment will be described in detail with reference to the drawings.

### First Example Embodiment

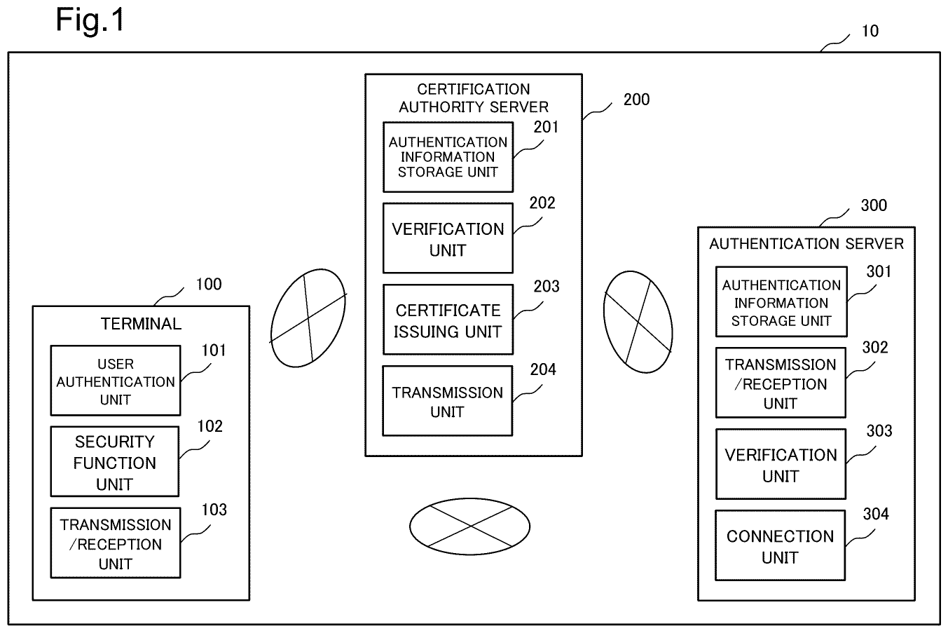

FIG. 1 is a block diagram illustrating a configuration of an authentication system 10 in the present disclosure. The authentication system 10 includes a terminal 100, a certification authority server 200, and an authentication server 300, which are connected to each other via a network. Although a single terminal 100 is illustrated in FIG. 1, a plurality of terminals 100 that connect to the network system may exist. The network system includes a service or a system used on a network. The authentication system 10 is a system for verifying authenticity of a user and a terminal when connecting to a network system. The authenticity refers to, for example, a property for confirming that the user or the terminal is not an impersonated user or terminal but a real user or terminal.

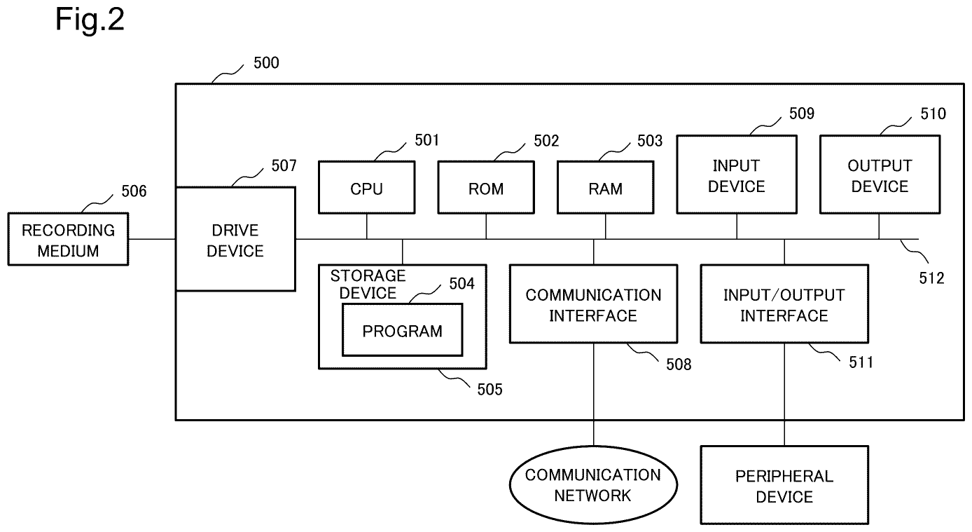

FIG. 2 is a diagram illustrating an example of a hardware configuration in which each of the terminal 100, the certification authority server 200, and the authentication server 300 in the first example embodiment of the present disclosure is achieved by a computer device 500 including a processor. As illustrated in FIG. 2, each of the terminal 100, the certification authority server 200, and the authentication server 300 includes a memory such as a central processing unit (CPU) 501, a read only memory (ROM) 502, and a random access memory (RAM) 503, a storage device 505 such as a hard disk that stores a program 504, a communication interface (I/F) 508 for network connection, and an input/output interface 511 that performs input/output of data. In the first example embodiment, the terminal 100, the certification authority server 200, and the authentication server 300 are connected to each component via a bus 512.

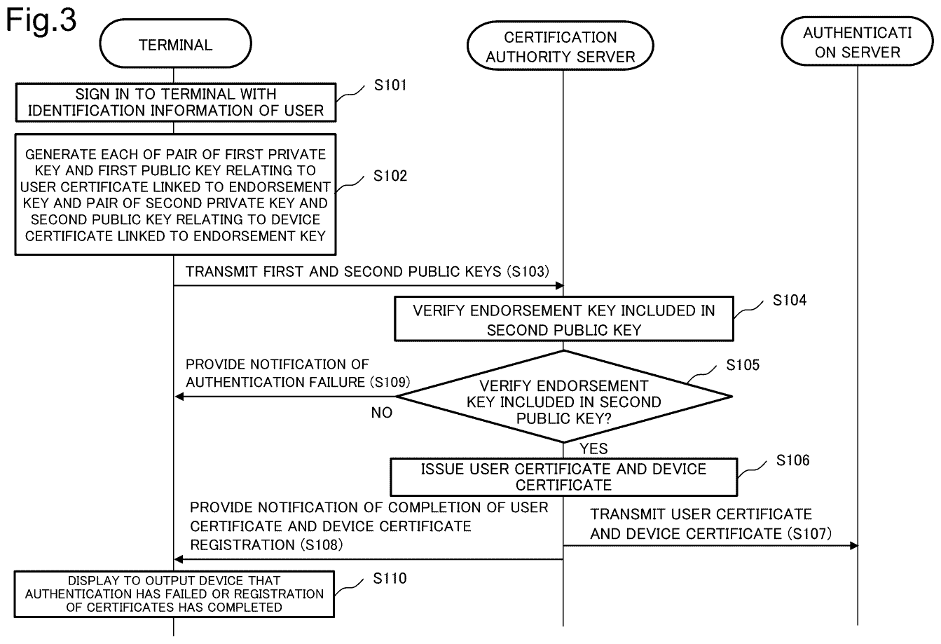

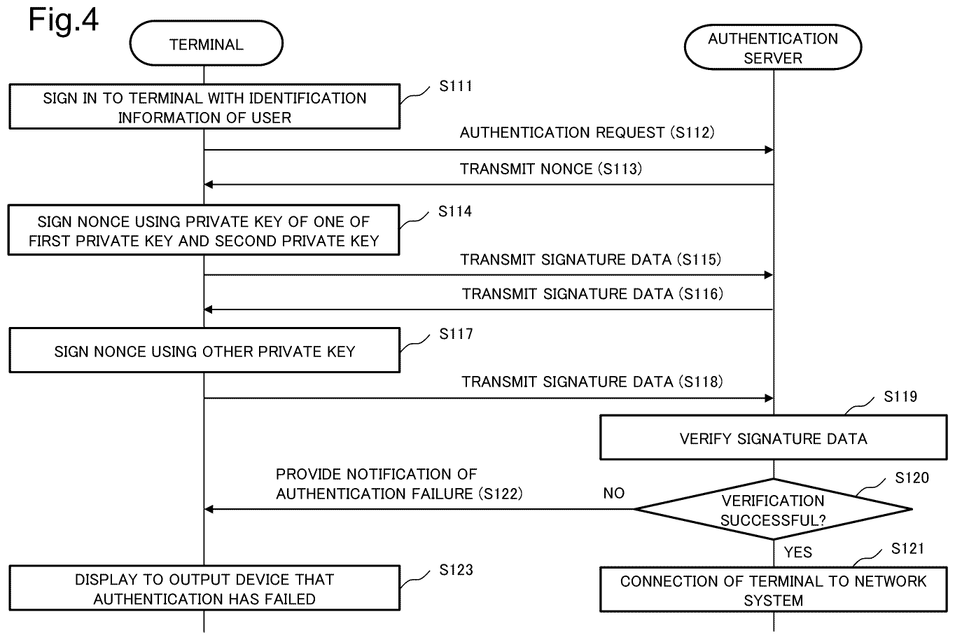

The CPU 501 operates the OS to control each of the terminal 100, the certification authority server 200, and the authentication server 300 according to the first example embodiment of the present invention. In addition, the CPU 501 reads programs and data from a recording medium 506 mounted in, for example, a drive device 507 or the like into a memory. In addition, the CPU 501 functions as an implementation means of each component included in the terminal 100, the certification authority server 200, and the authentication server 300 in the first example embodiment and a part thereof, and executes a process or a command in the flowcharts illustrated in FIGS. 3 and 4 described later based on a program.

Examples of the recording medium 506 include an optical disc, a flexible disk, a magnetic optical disc, an external hard disk, and a semiconductor memory. Part of the recording medium of the storage device is a non-volatile storage device, and records a program therein. The programs may be downloaded from an external computer (not illustrated) connected to a communication network.

An input device 509 is achieved by, for example, a mouse, a keyboard, a built-in key button, and the like, and is used for an input operation. The input device 509 is not limited to a mouse, a keyboard, and a built-in key button, and may be, for example, a touch panel. An output device 510 is achieved by, for example, a display, and is used to check an output.

As described above, the terminal 100, the certification authority server 200, and the authentication server 300 in FIG. 1 are achieved by the computer hardware illustrated in FIG. 2. However, implementation means of each component of the terminal 100, the certification authority server 200, and the authentication server 300 is not limited to the configuration described in the present specification.

### <Certificate Registration>

First, a method of registering a user certificate and a device certificate used for authentication in the authentication server 300 will be described.

### Terminal 100

As illustrated in FIG. 1, the terminal 100 is a device for using a network system. As illustrated in FIG. 1, a user authentication unit 101, a security function unit 102, and a transmission/reception unit 103 are provided.

The user authentication unit 101 collates identification information for identifying the user. The identification information includes one or a plurality of pieces of biological information such as a vein, a fingerprint, a palm, an iris, a voice, and a face, or a PIN code. The user authentication unit 101 accepts the identification information input from the user. In addition, the user authentication unit 101 may acquire the identification information of the user by reading data in the IC card storing the identification information. In addition, the user authentication unit 101 collates the input identification information with the identification information of the user stored in the terminal 100, and signs in to the terminal 100 when the collation is successful.

The security function unit 102 includes a storage area having tamper resistance. The security function unit 102 is a region where tampering by a malicious third party is difficult. The security function unit 102 is configured by a hardware encryption module, and is a trusted platform module (TPM) by way of example, but is not limited thereto as long as tamper resistance can be achieved. TPM has a characteristic in which tampering is difficult with respect to the OS, hardware, or physical hacking from the outside, and thus has high tamper resistance.

The security function unit 102 stores an endorsement key enclosed in the manufacturing process of the terminal 100. The endorsement key is provided with a unique identifier for each hardware encryption module and is used to identify the hardware encryption module.

The security function unit 102 generates a pair of a first private key and a first public key relating to a user certificate and a pair of a second private key and a second public key relating to a device certificate for authentication of the network system using a random number generation circuit. The user certificate and the device certificate are each linked to an endorsement key. The pair of the first private key and the first public key is used for verification of the user, and the pair of the second private key and the second public key is used for verification of the terminal 100. Each of the private keys is, for example, a private key in an Attestation Identity Key (AIK), and is paired with a user certificate and a device certificate, respectively, stored in the authentication server 300. Each security function unit 102 stores each of the generated private keys in a saving area of the hardware encryption module. The transmission unit 113 transmits each of the generated public keys to the certification authority server 200.

### Certification Authority Server 200

As illustrated in FIG. 1, the certification authority server 200 includes an authentication information storage unit 201, a verification unit 202, a certificate issuing unit 203, and a transmission unit 204.

The authentication information storage unit 201 stores an endorsement key certificate of the terminal 100. The endorsement key certificate includes information on the endorsement key and is received from the terminal 100 or the vendor of the terminal 100.

The verification unit 202 verifies the existence of the terminal 100 using the information of the endorsement key included in the second public key received from the terminal 100 by a known method using the endorsement key certificate. In a case where the existence of the terminal 100 has been verified, the verification unit 202 outputs the first and second public keys to the certificate issuing unit 203. On the other hand, in a case where the existence has not been verified, the verification unit 202 notifies the terminal 100 of the fact.

In a case where the second public key can be verified, the certificate issuing unit 203 issues a device certificate by adding a signature to the second public key by a signature generation key of the certification authority. Similarly, a signature is added to the first public key by the signature generation key of the certification authority to issue a user certificate. The certificate issuing unit 203 issues these certificates based on, for example, X.509. The certificate issuing unit 203 may set a valid period for each certificate.

The transmission unit 204 transmits the issued device certificate and user certificate to the authentication server 300. Each certificate may be encrypted by a predetermined method in order to enhance security. In addition, the transmission unit 204 notifies the terminal 100 that the registration of the device certificate and the user certificate has completed.

### <Authentication>

Next, a method of authenticating the user and the device by using the user certificate and the device certificate registered in the authentication server 300 will be described.

### Terminal 100

When accepting the identification information input from the user, the user authentication unit 101 collates the input identification information with the identification information of the user stored in the terminal 100, and when the collation is successful, signs in to the terminal 100 with the input identification information. In addition, the user authentication unit 101 transmits an authentication request requesting for verification of the user and the terminal 100 to the authentication server 300. The user authentication unit 101 transmits the authentication request using encrypted communication such as Secure Sockets Layer (SSL) or Transport Layer Security (TLS).

The security function unit 102 signs the predetermined data using the respective private keys of the first private key relating to the user certificate and the second private key relating to the device certificate. Specifically, first, the security function unit 102 signs the nonce transmitted from the authentication server 300 by using one of the first private key and the second private key, and the transmission/reception unit 103 transmits the signature data to the authentication server 300. Thereafter, the security function unit 102 signs the signed nonce transmitted again from the authentication server 300 using the other private key.

The transmission/reception unit 103 receives the nonce transmitted from the authentication server 300 through encrypted communication. In addition, the signature data signed by the respective private keys is transmitted to the authentication server 300 by encrypted communication.

### Authentication Server 300

The authentication server 300 includes an authentication information storage unit 301, a transmission/reception unit 302, a verification unit 303, and a connection unit 304. The authentication information storage unit 301 links and stores a user certificate and a device certificate for authentication of the network system. These certificates are issued by the certification authority server 200, and are certificates for verifying the signature data received from the terminal 100.

Upon receiving the authentication request from the terminal 100, the transmission/reception unit 302 transmits the nonce to the terminal 100 through encrypted communication. Furthermore, in a case where the signature data signed by either of the private keys is received, the transmission/reception unit 302 transmits a nonce with a signature to the terminal 100 through encrypted communication. In a case where the signature data signed by both the first and second private keys is received, the transmission/reception unit 302 outputs the signature data to the verification unit 303.

The verification unit 303 verifies the signature data using the user certificate and the device certificate. The verification method by the verification unit 303 is performed by a known method, and for example, the user and the device are verified by decrypting the signature data using the public key described in each certificate. In a case where a valid period is set for each certificate, the verification unit 303 also verifies whether it is within the valid period.

In a case where the user and the device can be verified, the connection unit 304 controls the network between the terminal 100 and the network system to enable connection of the terminal 100 to the network system. In a case where at least one of the user and the device cannot be verified, the connection unit 304 notifies the terminal 100 of the fact.

### <Flowchart>

FIGS. 3 and 4 are flowcharts illustrating an outline of an operation of the authentication system 10 in the present disclosure. The process according to these flowcharts may be executed based on the program control by the processor described above. The flowchart of FIG. 3 is an operation of registering the user certificate and the device certificate in the authentication server 300, and the flowchart of FIG. 4 is an operation of executing authentication of the user and the terminal 100.

First, an operation of registering a user certificate and a device certificate will be described. As illustrated in FIG. 3, first, in the terminal 100, the user authentication unit 101 signs in to the terminal 100 with the identification information input from the user (step S101). Next, the security function unit 102 generates a pair of a first private key and a first public key relating to the user certificate linked to the endorsement key and a pair of a second private key and a second public key relating to the device certificate linked to the endorsement key (step S102). The security function unit 102 stores each of the generated first and second private keys in the security function unit 102, and the transmission/reception unit 103 transmits each of the first and second public keys to the certification authority server 200 (step S103). When the certification authority server 200 receives the first and second public keys from the terminal 100, the verification unit 202 verifies the endorsement key included in the second public key (step S104). When verification is successful (S105; YES), the certificate issuing unit 203 issues the user certificate and the device certificate (step S106), the transmission unit 204 transmits the certificates to the authentication server 300 (step S107), and the transmission unit 204 provides notification that the registration of the certificates has been completed (step S108). On the other hand, when the verification is not successful (S105; NO), the transmission unit 204 provides notification that the verification has failed (step S109). Finally, the output device 510 of the terminal 100 displays that the authentication has failed or the registration of the certificate has completed (step S110). As described above, the authentication system 10 ends the operation of registering the user certificate and the device certificate.

Next, the operation of authenticating the user and the terminal 100 will be described. As illustrated in FIG. 4, first, the user authentication unit 101 of the terminal 100 signs in to the terminal 100 with the identification information input from the user (step S111), and transmits an authentication request to the authentication server 300 (step S112). Next, in the authentication server 300, the transmission/reception unit 302 transmits the nonce to the terminal 100 (step S113). Next, in the terminal 100, the security function unit 102 signs the nonce using one of the first private key and the second private key (step S114), and transmits signature data to the authentication server 300 (step S115). Next, the authentication server 300 again transmits the signature data signed by one of the private keys to the terminal 100 (step S116), and the security function unit 102 signs the nonce using the other private key (step S117) and again transmits the nonce to the authentication server 300 (step S118).

Next, when receiving the signature data signed by both private keys, the verification unit 303 verifies the signature data using the user certificate and the device certificate (step S119). When verification is successful (S120; YES), the connection unit 304 enables connection of the terminal 100 to the network system (step S121). On the other hand, when the verification is not successful (S120; NO), the transmission/reception unit 302 notifies the terminal 100 that the authentication has failed (step S122), and displays that the authentication has failed on the output device 510 of the terminal 100 (step S123). As described above, the authentication system 10 ends the operation of authenticating the user and the device.

In the present example embodiment, in the operation of authenticating the user and the terminal 100, the security function unit 102 of the terminal 100 signs the nonce transmitted from the authentication server 300 using the respective private keys of the first private key relating to the user certificate and the second private key relating to the device certificate, and the verification unit 303 of the authentication server 300 verifies the signature data using the user certificate and the device certificate. As a result, it is possible to verify that the network system is being accessed using a real user and device. Therefore, it is possible to verify that impersonation of the user and the terminal 100 has not been performed.

Furthermore, in the present example embodiment, the authentication system 10 performs verification using signature data obtained by signing a nonce with each private key and the certificates without using information regarding the user and the terminal 100. Therefore, verification can be performed while protecting the confidential information of the user who is the person to be authenticated and the confidential information of the terminal 100.

As described above, according to the present example embodiment, the authenticity of the user and the terminal can be verified while protecting the confidential information of the user and the terminal 100.

In addition, in the present example embodiment, an endorsement key for identifying a hardware encryption module is linked to a user certificate, a device certificate, and private keys corresponding thereto. As a result, not only the verification of the authenticity of the terminal 100 but also the verification of existence that the terminal 100 exists can be performed.

### Modified Example of First Example Embodiment

A modified example of the first example embodiment of the present disclosure will be described. In the first example embodiment described above, encrypted communication in which data is exchanged at the time of performing signature using one of either the first private key and the second private key and encrypted communication in which data is exchanged at the time of performing signature using the other private key are the same. On the other hand, another encrypted communication may be used to exchange data when performing each signature. That is, the security function unit 102 signs a nonce received from the authentication server 300 by the first encrypted communication at the time of connection to the network system by using one private key of the first private key and the second private key, and transmits the signature data to the authentication server 300 by the first encrypted communication via the transmission/reception unit 103. In addition, the security function unit 102 signs the nonce with the signature data received from the authentication server 300 through the second encrypted communication using the other private key, and transmits the signature data signed by the first private key and the second private key to the authentication server 300 through the second encrypted communication via the transmission/reception unit 103.

In addition, the security function unit 102 may sign the nonce received from the authentication server 300 at the time of connection to the network system by using an aggregate signature in which the first private key and the second private key are aggregated. As the aggregated signature, for example, a Schnorr signature can be used. In this case, the number of times of exchanging data when transmitting the signature data can be reduced, and the transmission load of the network can be reduced.

### Application Example

Examples of a network system to which the authentication system 10 of the present disclosure can be applied include, for example, an automatic driving system. In this case, the authentication system 10 authenticates the user by verifying the authenticity of the user and the terminal 100 mounted on the automobile of the user. In this system, when the user is authenticated, the user can use the automatic driving system in his/her own automobile.

Other network systems to which the authentication system 10 of the present disclosure can be applied include automobile rental systems. In this network system, the user certificate includes information on the valid period, and the valid period relating to the automobile rental time is set. In this case, the authentication system 10 verifies the authenticity of the user and the terminal 100 mounted on the automobile used by the user, and also verifies whether the user certificate is within a valid period. According to this system, the authentication of the user is performed only when the user certificate is within the valid period, and the connection to the system for driving the automobile can be enabled only within the rental time.

Although the present invention is described with reference to each example embodiment, the present invention is not limited to the above example embodiments. Various modifications that can be understood by those of ordinary skill in the art can be made to the configuration and details of the present invention within the scope of the present invention. For example, although the plurality of operations is described in order in the form of a flowchart, the order of description does not limit the order in which the plurality of operations is executed. Therefore, when each example embodiment is implemented, the order of the plurality of operations can be changed within a range that does not interfere with the content.

Some or all of the above example embodiments can also be described as the following Supplementary Notes. However, some or all of the above example embodiments are not limited to the following.

### Supplementary Note 1

An authentication system including a terminal and an authentication server for using a network system from the terminal, in which
the terminal includes,
a security function means for generating a first private key relating to a user certificate that is linked to an endorsement key, and a second private key relating to a device certificate that is linked to the endorsement key, and signing predetermined data using each of the private keys, and
a transmission/reception means for transmitting, to the authentication server, signature data signed by each of the first private key and the second private key through encrypted communication, and
the authentication server includes,
a verification means for verifying the signature data by using the user certificate and the device certificate held in advance, and
a connection means for enabling, when the user and the device are verified, connection of the terminal to the network system.

### Supplementary Note 2

The authentication system according to supplementary note 1, in which
the security function means performs a signature on a nonce received from the authentication server through encrypted communication at the time of connection to the network system using a private key of one of the first private key and the second private key, and transmits signature data to the authentication server via the transmission/reception means through encrypted communication, and
after the transmission of the signature data, performs a signature on a nonce with signature data received from the authentication server through the encrypted communication using the other private key, and transmits signature data signed by the first private key and the second private key to the authentication server via the transmission/reception means through the encrypted communication.

### Supplementary Note 3

The authentication system according to supplementary note 1, in which
the security function means performs a signature on a nonce received from the authentication server through a first encrypted communication at the time of connection to the network system using a private key of one of the first private key and the second private key, and transmits signature data to the authentication server via the transmission/reception means through the first encrypted communication, and
after the transmission of the signature data, performs a signature on a nonce with signature data received from the authentication server through a second encrypted communication using the other private key, and transmits signature data signed by the first private key and the second private key to the authentication server via the transmission/reception means through the second encrypted communication.

### Supplementary Note 4

The authentication system according to supplementary note 1, in which the security function means performs signature on a nonce received from the authentication server through encrypted communication at the time of connection to the network system by using a private key in which the first private key and the second private key are aggregated.

### Supplementary Note 5

The authentication system according to any one of supplementary notes 1 to 4, in which
the user certificate includes information relating to a valid period, and
the authentication server permits connection of the terminal to the network system only within the valid period.

### Supplementary Note 6

The authentication system according to any one of supplementary notes 1 to 5, in which
the authentication system further includes a certification authority server, and
the certification authority server includes,
a verification means for verifying existence of the terminal when issuance of the device certificate is requested from the terminal, and
a certificate issuing means for issuing the user certificate and the device certificate when the existence is confirmed.

### Supplementary Note 7

The authentication system according to any one of supplementary notes 1 to 6, in which the network system is an automatic driving system.

### Supplementary Note 8

The authentication system according to any one of supplementary notes 1 to 6, in which
the network system is an automobile rental system, and a valid period relating to a rental time is set in the user certificate.

### Supplementary Note 9

A terminal including:
a security function means for generating a first private key relating to a user certificate that is linked to an endorsement key and a second private key relating to a device certificate that is linked to the endorsement key, and signing predetermined data using each of the private keys, and
a transmission/reception means for transmitting signature data signed by each of the first private key and the second private key to an authentication server for authenticating a user and a device through encrypted communication.

### Supplementary Note 10

An authentication server including:
a verification means for verifying a user and a device by using a user certificate and a device certificate held in advance for signature data signed by each of a first private key relating to the user certificate that is linked to an endorsement key and a second private key relating to a device certificate that is linked to the endorsement key received from a terminal to be authenticated, and
a connection means for enabling, when the user and the device are verified, connection of the terminal to the network system.

### Supplementary Note 11

An authentication method for authenticating a terminal to use a network system by an authentication server, in which
the terminal generates a first private key relating to a user certificate that is linked to an endorsement key, and a second private key relating to a device certificate that is linked to the endorsement key, and signs predetermined data using each of the private keys, and
transmits, to the authentication server, signature data signed by each of the first private key and the second private key through encrypted communication,
the authentication server verifies the signature data by using the user certificate and the device certificate held in advance, and
enables, when the verification is successful, connection of the terminal to the network system.

### Supplementary Note 12

A recording medium storing a program for causing a computer to:
generate a first private key relating to a user certificate that is linked to an endorsement key and a second private key relating to a device certificate that is linked to the endorsement key, and sign predetermined data using each of the private keys, and
transmit signature data signed by each of the first private key and the second private key to an authentication server for authenticating a user and a device through encrypted communication.

### Supplementary Note 13

A recording medium storing a program for causing a computer to:
verify signature data signed by each of a first private key relating to a user certificate that is linked to an endorsement key and a second private key relating to a device certificate that is linked to the endorsement key received from a terminal to be authenticated using the user certificate and the device certificate held in advance, and
enable, when the verification is successful, connection of the terminal to the network system.

### REFERENCE SIGNS LIST

10 authentication system
100 terminal
101 user authentication unit
102 security function unit
103 transmission/reception unit
200 certification authority server
201 authentication information storage unit
202 verification unit
203 certificate issuing unit
204 transmission unit
300 authentication server
301 authentication information storage unit
302 transmission/reception unit
303 verification unit
304 connection unit
500 computer device
501 CPU
502 ROM
503 RAM
504 program
505 storage device
506 recording medium
507 drive device
508 communication interface
509 input device
510 output device
511 input/output interface
512 bus

What is claimed is:

1. An authentication system including a terminal and an authentication server for using a network system from the terminal, the authentication system comprising:
the terminal including,
at least one memory storing instructions; and
at least one processor configured to execute the instructions to:
generate a first private key relating to a user certificate that is linked to an endorsement key, and a second private key relating to a device certificate that is linked to the endorsement key;
sign predetermined data using each of the private keys; and
transmit, to the authentication server, signature data signed by each of the first private key and the second private key through encrypted communication; and
the authentication server including,
at least one memory storing instructions; and
at least one processor configured to execute the instructions to:
verify the signature data by using the user certificate and the device certificate held in advance; and
enable when the user and the device are verified, connection of the terminal to the network system.

2. The authentication system according to claim 1,
wherein the at least one processor of the terminal is further configured to execute the instructions to:
perform a signature on a nonce received from the authentication server through encrypted communication at the time of connection to the network system using a private key of one of the first private key and the second private key;
transmit signature data to the authentication server through encrypted communication;
after the transmission of the signature data, perform a signature on a nonce with signature data received from the authentication server through the encrypted communication using the other private key; and
transmit signature data signed by the first private key and the second private key to the authentication server through the encrypted communication.

3. The authentication system according to claim 1,
wherein the at least one processor of the terminal is further configured to execute the instructions to:
perform a signature on a nonce received from the authentication server through a first encrypted communication at the time of connection to the network system using a private key of one of the first private key and the second private key;
transmit signature data to the authentication server through the first encrypted communication;
after the transmission of the signature data, perform a signature on a nonce with signature data received from the authentication server through a second encrypted communication using the other private key; and
transmit signature data signed by the first private key and the second private key to the authentication server through the second encrypted communication.

4. The authentication system according to claim 1,
wherein the at least one processor of the terminal is further configured to execute the instructions to:
perform signature on a nonce received from the authentication server through encrypted communication at the time of connection to the network system by using a private key in which the first private key and the second private key are aggregated.

5. The authentication system according to claim 1, wherein
the user certificate includes information relating to a valid period; and
the authentication server permits connection of the terminal to the network system only within the valid period.

6. The authentication system according to claim 1, wherein
the authentication system further comprising:
the certification authority server including,
at least one memory storing instructions; and
at least one processor configured to execute the instructions to:
verify existence of the terminal when issuance of the device certificate is requested from the terminal; and
issue the user certificate and the device certificate when the existence is confirmed.

7. The authentication system according to claim 1, wherein the network system is an automatic driving system.

8. The authentication system according to claim 1, wherein
the network system is an automobile rental system, and a valid period relating to a rental time is set in the user certificate.

9. A terminal comprising:
at least one memory storing instructions; and
at least one processor configured to execute the instructions to:
generate a first private key relating to a user certificate that is linked to an endorsement key and a second private key relating to a device certificate that is linked to the endorsement key;
sign predetermined data using each of the private keys; and
transmit signature data signed by each of the first private key and the second private key to an authentication server for authenticating a user and a device through encrypted communication.

10. (Canceled)

11. An authentication method for authenticating a terminal to use a network system by an authentication server, the authentication method, comprising:
by the terminal,
generating a first private key relating to a user certificate that is linked to an endorsement key, and a second private key relating to a device certificate that is linked to the endorsement key;
signing predetermined data using each of the private keys; and
transmitting, to the authentication server, signature data signed by each of the first private key and the second private key through encrypted communication; and
by the authentication server,
verifying the signature data by using the user certificate and the device certificate held in advance, and enabling, when the verification is successful, connection of the terminal to the network system.

12.-cm 13. (canceled)

14. The authentication method according to claim 11, further comprising:
by the terminal,
performing a signature on a nonce received from the authentication server through encrypted communication at the time of connection to the network system using a private key of one of the first private key and the second private key;
transmitting signature data to the authentication server through encrypted communication;
after the transmission of the signature data, performing a signature on a nonce with signature data received from the authentication server through the encrypted communication using the other private key; and
transmitting signature data signed by the first private key and the second private key to the authentication server through the encrypted communication.

15. The authentication method according to claim 11, further comprising:
by the terminal,
performing a signature on a nonce received from the authentication server through a first encrypted communication at the time of connection to the network system using a private key of one of the first private key and the second private key;
transmitting signature data to the authentication server through the first encrypted communication;
after the transmission of the signature data, performing a signature on a nonce with signature data received from the authentication server through a second encrypted communication using the other private key; and
transmitting signature data signed by the first private key and the second private key to the authentication server through the second encrypted communication.

16. The authentication method according to claim 11, further comprising:
by the terminal,
performing signature on a nonce received from the authentication server through encrypted communication at the time of connection to the network system by using a private key in which the first private key and the second private key are aggregated.

17. The authentication method according to claim 11, wherein
the user certificate includes information relating to a valid period; and
the authentication server permits connection of the terminal to the network system only within the valid period.

18. The authentication method according to claim 11, further comprising:
by the certification authority server,
verifying existence of the terminal when issuance of the device certificate is requested from the terminal; and
issuing the user certificate and the device certificate when the existence is confirmed.

19. The authentication method according to claim 11, wherein the authentication method is an automatic driving method.

20. The authentication method according to claim 11, wherein
the authentication method is an automobile rental method, and a valid period relating to a rental time is set in the user certificate.
